(19) United States
(12) Patent Application Publication
(10) Pub. No.: US 2004/0016321 A1
(43) Pub. Date: Jan. 29, 2004

(54) Pipe wrench

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/205,464

(22) Filed: Jul. 26, 2002

(51) Int. Cl. B25B 13/46

(52) U.S. Cl. 81/60

(57) ABSTRACT

A pipe wrench includes a C-shaped head including two jaws and a space is partially enclosed by the two jaws. A passage is defined in an inside of the head and communicates with the space. A spring and an end member is received in the passage. A C-shaped engaging member is rotatably engaged with the space between the two jaws and has a toothed outer surface which is engaged with the pawl. When the opening of the head and the engaging member is in alignment with each other, the wrench is able to remove from the object to be tightened or loosened.

### FIELD OF THE INVENTION

The present invention relates to a pipe wrench that has a C-shaped head and a C-shaped engaging member which is rotatably engaged with the head and a ratchet mechanism is engaged with the engaging member.

### BACKGROUND OF THE INVENTION

A conventional wrench used on piping system is shown in FIG. 1 and an inherent shortcoming is that the jaws of the conventional wrench are wide and thick and the pipes are located very close to each other so that when rotating the wrench the jaws are blocked by the pipes around the object. FIG. 2 shows a conventional box end wrench that has thinner ring portion so that the wrench is convenient to rotate among the pipes. Nevertheless, the conventional wrench has to be disengaged from the object after it is rotated an angle which is limited especially when the space between the pipes is narrow. The frequent disengagement and engagement of the wrench and the object take a lot of time and reduce the efficiency of the work.

The present invention intends to provide a pipe wrench that has a ratchet mechanism and a C-shaped head and a C-shaped member is rotatably engaged in the head so that the wrench can be continuously rotated.

### SUMMARY OF THE INVENTION

In accordance with one aspect of the present invention, there is provided a pipe wrench which comprises a C-shaped head including two jaws and a passage is defined in an inside of the head and communicates with a space enclosed by the two jaws. A C-shaped engaging member is rotatably engaged with the space between the two jaws and has a toothed outer surface which is engaged with a pawl which is biased by a spring and both are received in the passage.

The primary object of the present invention is to provide a ratchet pipe wrench which can be operated in a narrow space and the biasing assembly for biasing the pawl provides a stable operational condition.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional wrench and a piping system;

FIG. 2 shows a conventional pipe wrench and a pipe system;

FIG. 3 is an exploded view to show a pipe wrench of the present invention;

FIG. 4 shows the biasing assembly in the pipe wrench of the present invention;

FIG. 5 is a perspective view to show the pipe wrench of the present invention;

FIGS. 6 to 8 respectively show the positioning of the spring of the biasing assembly;

FIG. 9 shows an exploded view to show another embodiment of the pipe wrench of the present invention.

FIG. 9A shows a cross sectional view of the embodiment in FIG. 9;

FIG. 10 shows a pawl in the wrench to engage with the engaging member in the head;

FIG. 11 shows another embodiment of the biasing assembly of the wrench of the present invention;

FIGS. 12 and 13 show two embodiments of the biasing assembly of the wrench of the present invention, and

FIGS. 14 to 17 respectively show the positioning of the spring of the biasing assembly.

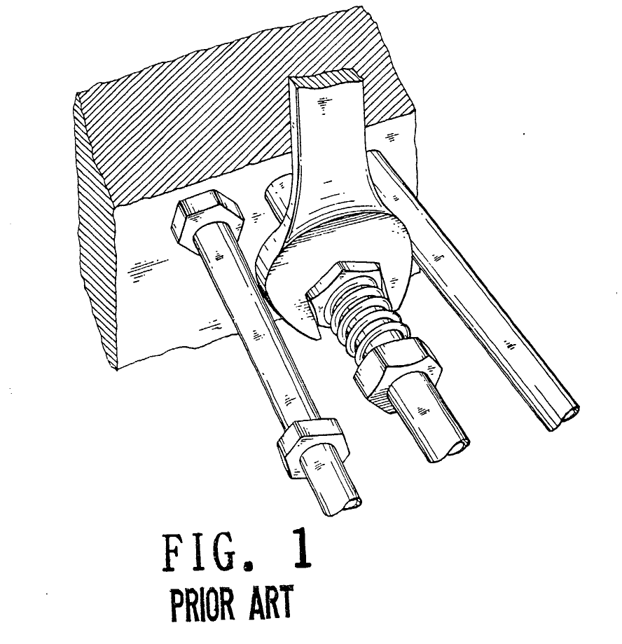

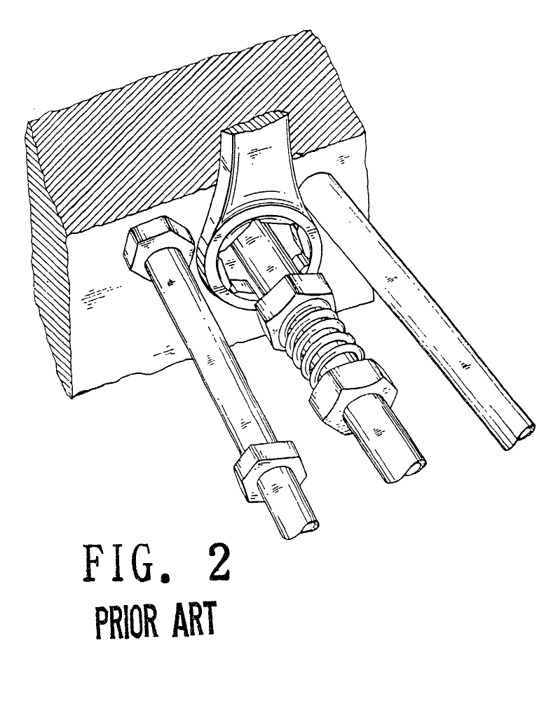

### DETAILED DESCRIPTION OF THE PREFERRED EMBODIMENT

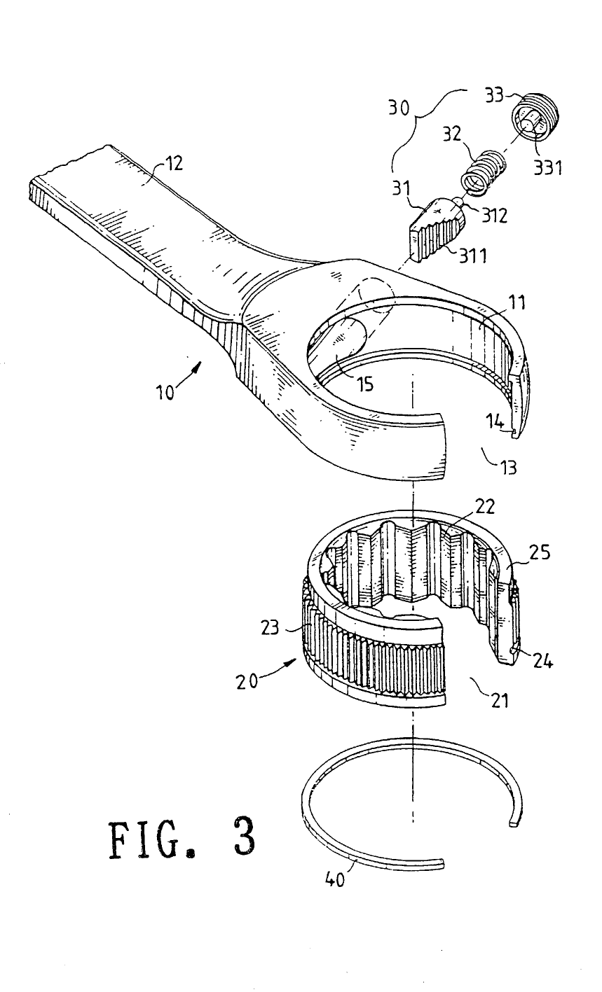

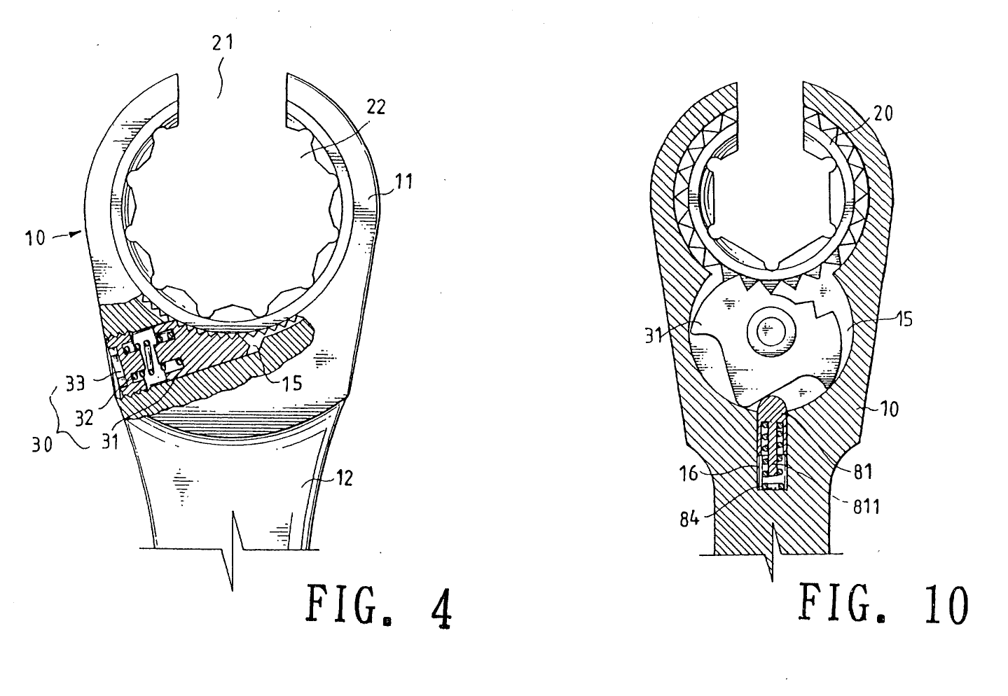

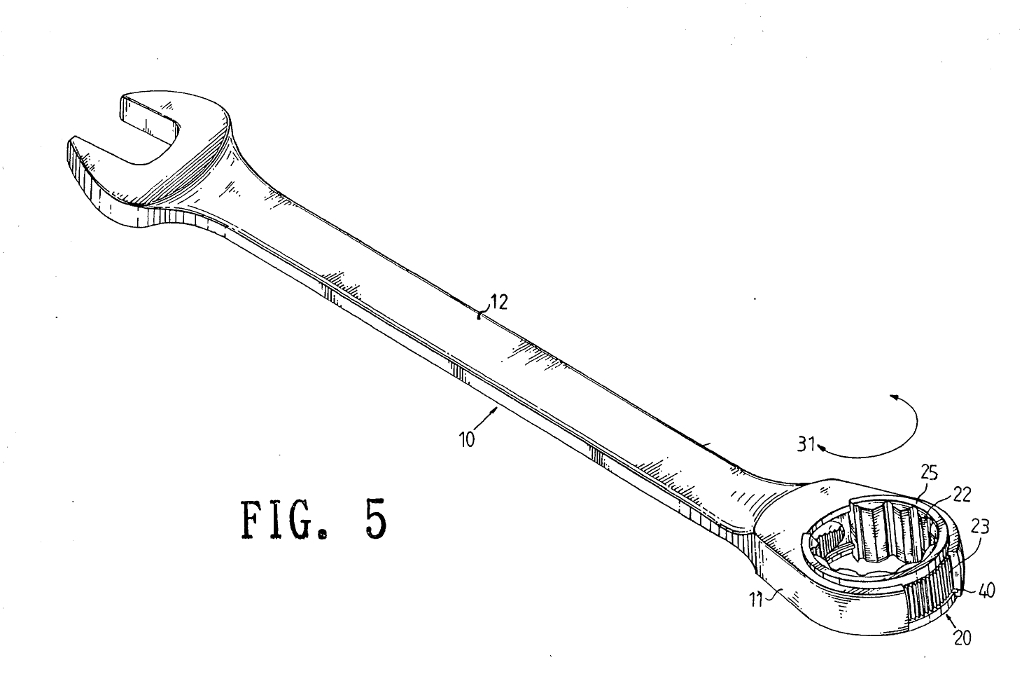

Referring to FIGS. 3 to 5, the pipe wrench 10 of the present invention comprises a C-shaped head 11 and a shank 12 is connected to the head 11 which includes two jaws and a passage 15 is defined in an inside of the head 11 and communicates with a space enclosed by the two jaws. A C-shaped engaging member 20 is rotatably engaged with the space between the two jaws and has a toothed outer surface 23. A C-shaped retaining member 40 is engaged with a groove defined in an outside of the engaging member 20 and a groove 14 defined in the inside of the head 11 so as to retain the engaging member 20 in position. The engaging member 20 has a serrated inner periphery for engaging with an object such as a nut and a flange 25 extends from a side of the engaging member 20. The flange 25 extends from a side of the head 11 so that the user may rotate the engaging member 20 by rotating the flange 25.

A biasing assembly 30 is received in the passage 15 and includes a pawl 31, a spring 32 and an end member 33 which seals the opening to the outside of the head 11. The opening communicating with the space between the two jaws of the head 11 is sized that the pawl 31 does not drop therefrom and the teeth 311 on the pawl 31 are engaged with the toothed outer surface 23 of the engaging member 20. The pawl 31 has a first protrusion 312 extending from an end thereof and the end member 33 has a second protrusion 331. Two ends of the spring 32 are engaged with the first protrusion 312 and the second protrusion 331. The spring 32 is well positioned and the pawl 31 is therefore biased by the spring 32 in a stable condition and may perform as desired. The ratchet wrench has thin jaws and can be easily rotated in a narrow space. The wrench is able to disengaged from the object by removing the object from the aligned openings 13, 21 of the head 11 and the engaging member 20.

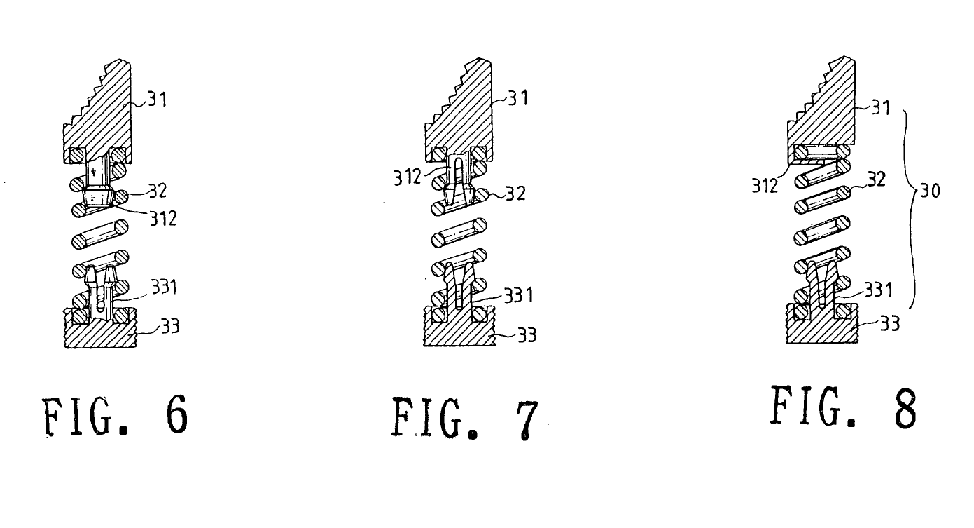

FIGS. 6 to 8 show three embodiments of the protrusions 312 and 311, wherein the first protrusion 312 or the second protrusion 331 may have a slot and each of the first protrusion 312 and the second protrusion 331 has an enlarged head which is split outward to position the spring 32. The first protrusion can also be a side recess to receive an end of the spring 32.

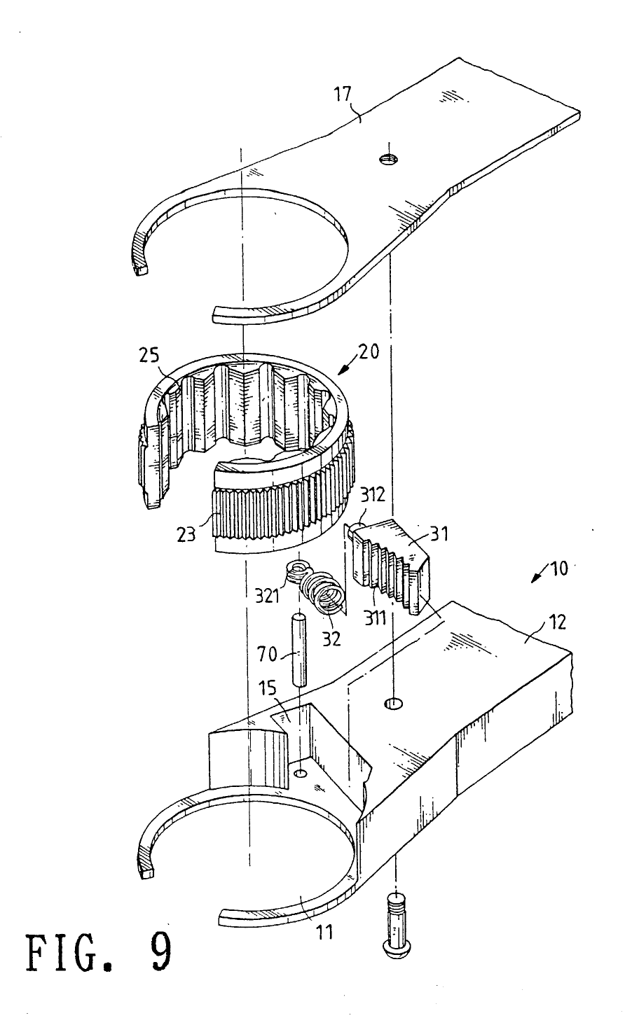

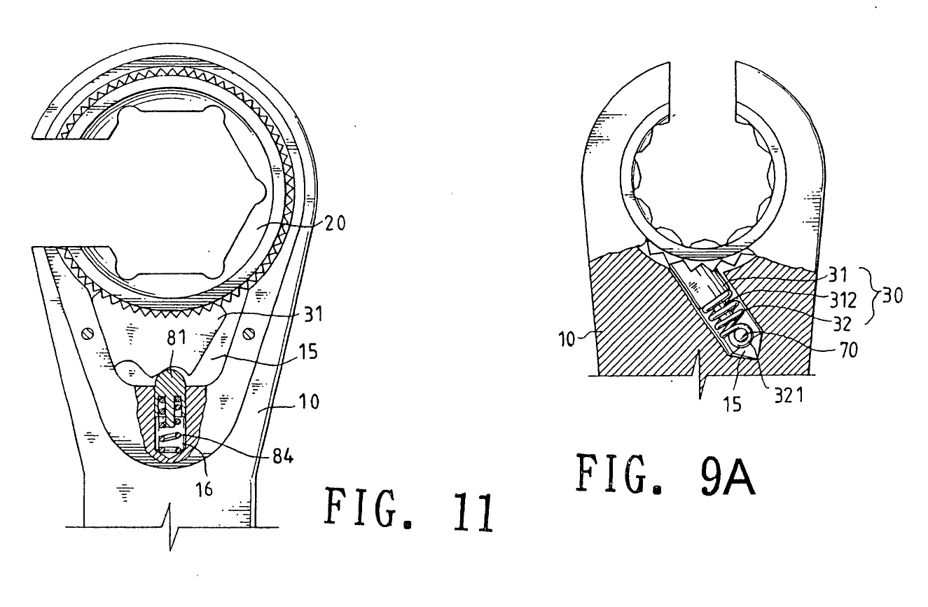

As shown in FIGS. 9 and 9A, the passage 15 does not communicate with the outside of the head 11 and is ended in the head 11. One of the two ends of the spring 32 has a ring 321 and a pin 70 extends through the ring 321.

FIG. 10 shows that the pipe wrench comprises a C-shaped head 11 including two jaws and a recess 150 is defined in an inside of the head 11 and communicates with a space enclosed by the two jaws. A C-shaped engaging member 20 is rotatably engaged with the space between the two jaws. A pawl 31 is rotatably received in the recess 150 and a first side of the pawl 31 is engaged with the toothed outer surface 23. A passage 16 is defined in an inside of the recess 159 and a positioning member 81 and a spring 84 are received in the passage 16. The positioning member 81 has a rod 811 extending therefrom and the spring 84 is mounted to the rod 811. The positioning member 81 is engaged with a protrusion extending from a second side of the pawl 31. The pawl 31 is pivoted by a lever connected thereto which is controlled by the user. FIG. 11 shows a similar ratchet wrench as that shown in FIG. 10, wherein the opening of the head 11 and the engaging member 20 are located at a side of the wrench.

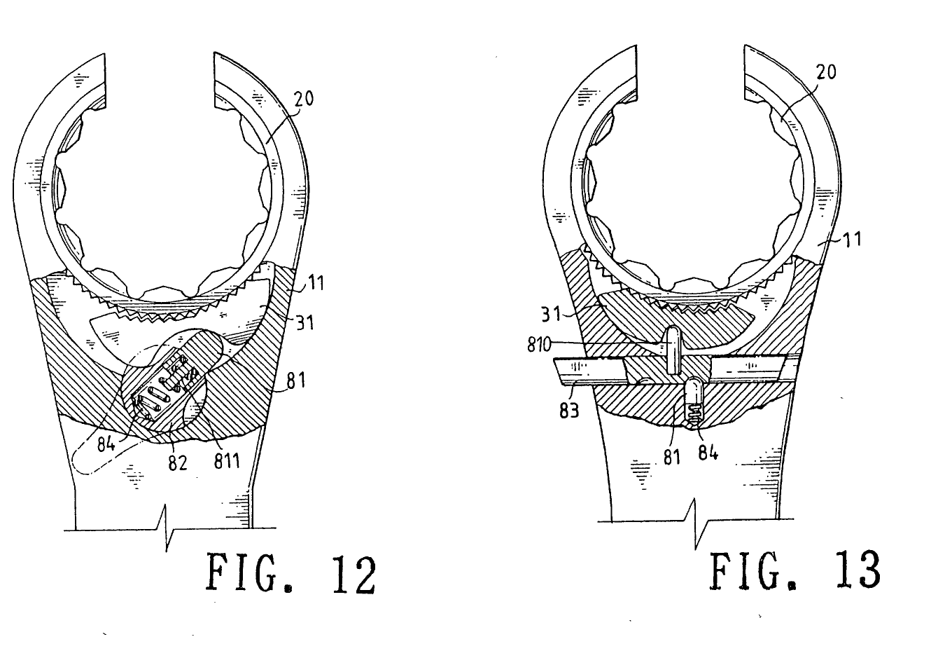

FIG. 12 shows a carrying member 82 is rotatably received in the passage and has a concavity in which the spring 84 and the positioning member 81 are received. A lever shown by dotted lines is connected to the carrying member 82 and is rotated to control the position of the positioning member 81.

FIG. 13 shows a communicating passage is defined transversely through the head 11 and in communication with the recess for receiving the pawl 31 and the passage for receiving the positioning member 81 and the spring 84. A mediate member 83 is movably received in the communicating passage and another positioning member 810 is connected to the mediate member 83. Two notches are defined in an outer surface of the mediate member 83 and the positioning member 81 biased by the spring 84 is engaged with one of the two notches. The user may push the mediate member 83 to control the position of the pawl 31.

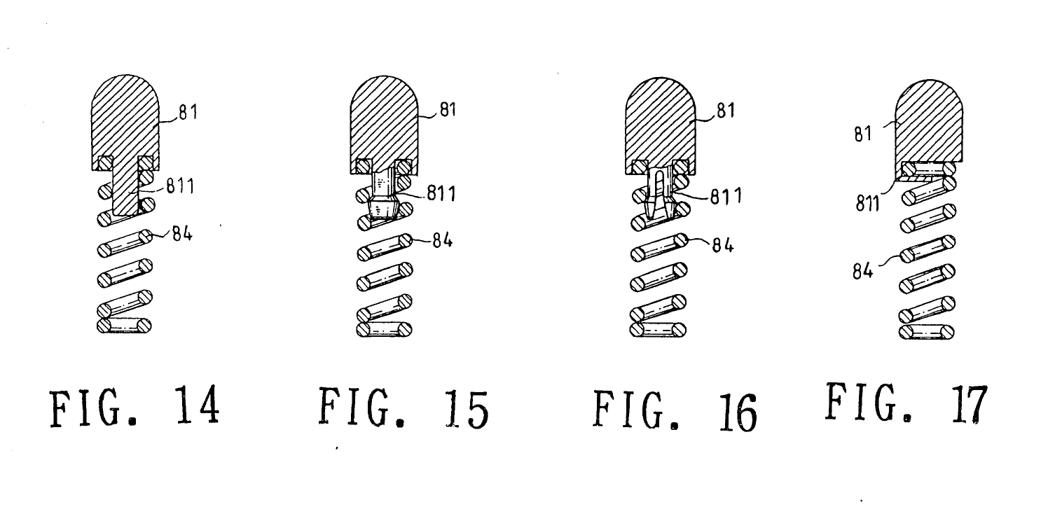

FIGS. 14 to 17 show the different ways to position the spring 84 to the positioning member 81. The rod 811 may have an enlarged head, a slot or a side recess to position one end of the spring 84.

While we have shown and described the embodiment in accordance with the present invention, it should be clear to those skilled in the art that further embodiments may be made without departing from the scope of the present invention.

What is claimed is:

1. A pipe wrench comprising:
a C-shaped head including two jaws and a passage defined in an inside of the head and communicating with a space enclosed by the two jaws, a pawl, a spring and an end member received in the passage, and
a C-shaped engaging member rotatably engaged with the space between the two jaws and having a toothed outer surface, the pawl engaged with the toothed outer surface.

2. The pipe wrench as claimed in claim 1, wherein the pawl has a first protrusion extending from an end thereof and the end member has a second protrusion, two ends of the spring engaged with the first protrusion and the second protrusion.

3. The pipe wrench as claimed in claim 2, wherein at least one of the first protrusion and the second protrusion has a slot defined longitudinally therein.

4. The pipe wrench as claimed in claim 2, wherein one of the two ends of the spring has a ring and a pin extends through the ring.

5. The pipe wrench as claimed in claim 1, wherein the passage opens to an outside of the head and the end member seals an opening communicating with the outside of the head.

6. A pipe wrench comprising:
a C-shaped head including two jaws and a recess defined in an inside of the head and communicating with a space enclosed by the two jaws, a C-shaped engaging member rotatably engaged with the space between the two jaws and having a toothed outer surface, a pawl movably received in the recess and a first side of the pawl engaged with the toothed outer surface, and
a passage defined in an inside of the recess and a positioning member and a spring received in the passage, the positioning member engaged with a second side of the pawl.

7. The pipe wrench as claimed in claim 6 further comprising a carrying member rotatably received in the passage and having a concavity in which the spring and the positioning member are received.

8. The pipe wrench as claimed in claim 6 further comprising a communicating passage defined through the head and being in communication with the recess and the passage, a mediate member movably received in the communicating passage and the positioning member connected to the mediate member, two notches defined in an outer surface of the mediate member and the spring engaged with one of the two notches.
